(19) United States
(12) Patent Application Publication
(10) Pub. No.: US 2025/0378616 A1
(43) Pub. Date: Dec. 11, 2025

(54) Pose-Based Facial Expressions

(71) Applicant: Meta Platforms Technologies, LLC, Menlo Park, CA (US)

(72) Inventors: Jonas SCHMIDTLER, Aliso Viejo, CA (US); Nahal NOROUZI, Bellevue, WA (US); Zhengzhe ZHU, Redmond, WA (US)

(21) Appl. No.: 19/201,253

(22) Filed: May 7, 2025

Related U.S. Application Data
(60) Provisional application No. 63/656,199, filed on Jun. 5, 2024.

(51) Int. Cl. G06T 13/40; G06V 10/82; G06V 40/10; G06V 40/16

(52) U.S. Cl. CPC G06T 13/40; G06V 10/82; G06V 40/15; G06V 40/174

(57) ABSTRACT

A device of the subject technology comprises a extra-reality (XR) headset including a processor configured to execute machine-learning (ML) instructions, memory configured to store a first set of data and a communications module configured to access a cloud storage including a second set of data. The ML instructions are configured to train an artificial-intelligence (AI) model to infer facial expressions based on at least one of the first set of data or the second set of data.

### TECHNICAL FIELD

The present disclosure generally relates to artificial intelligence (AI) applications, and more particularly to pose-based facial expressions.

### BACKGROUND

Facial expressions are a form of nonverbal communication that involves one or more motions or positions of the muscles beneath the skin of the face. These movements are believed to convey the emotional state of an individual to observers. Human faces are exquisitely capable of a vast range of expressions, such as showing fear to send signals of alarm, interest to draw others toward an opportunity, or fondness and kindness to increase closeness.

AI has revolutionized the field of body movement tracking, opening new possibilities in various sectors such as fitness, healthcare, gaming, and animation. AI-powered motion-capture and body-tracking technologies have made it possible to generate three-dimensional (3D) animations from video in seconds. These systems use AI to analyze and interpret physical movements and postures, providing valuable data regarding a user's physical condition and progress. They are accessible and easy to use, requiring only a standard webcam or smartphone camera.

For example, in the fitness industry, AI-powered body scanning technologies are being used to track and analyze users' exercise routines. These systems can provide real-time feedback on the user's form and technique, helping to prevent injuries and improve workout efficiency. Also, AI-powered body tracking allows for more realistic and dynamic character movements in the field of animation and gaming. Moreover, AI-powered body posture detection and motion tracking are also being used in healthcare for enhanced exercise experiences.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 is a high-level block diagram illustrating a network architecture within which some aspects of the subject technology are implemented.

FIG. 2 is a block diagram illustrating details of a system including a client device and a server, as discussed herein.

FIG. 3 is a block diagram illustrating examples of application modules used in the client device of FIG. 2, according to some embodiments.

FIG. 4 is a screen shot illustrating an example of a facial expression inferred from a form of a hand-in the-air body gesture, according to some embodiments.

FIG. 5 is a screen shot illustrating an example of a facial expression inferred from a form of a stop body gesture, according to some embodiments.

FIG. 6 is a screen shot illustrating an example of a facial expression inferred from a form of a peace sign body gesture, according to some embodiments.

FIG. 7 is a screen shot illustrating an example of a facial expression inferred from a form of a punching body gesture, according to some embodiments.

FIG. 8 is a flow diagram illustrating an example of a method of inferring facial expression from body gestures, according to some embodiments.

FIG. 9 is a flow diagram illustrating an example of a method of inferring facial expression from body poses, according to some embodiments.

FIG. 10 is a block diagram illustrating an overview of devices on which some implementations can operate.

FIG. 11 is a block diagram illustrating an overview of an environment in which some implementations can operate.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

According to some embodiments, a device of the subject technology includes an extra-reality (XR) headset comprising a processor configured to execute machine-learning (ML) instructions, memory configured to store a first set of data and a communications module configured to access a cloud storage including a second set of data. The ML instructions are configured to train an AI model to infer facial expressions based on at least one of the first set of data or the second set of data.

According to some embodiments, an apparatus comprises an XR headset including a processor configured to execute ML instructions, memory configured to store a first set of data and a communications module configured to access a cloud storage including a second set of data. At least one of the first set of data or the second set of data includes a plurality of facial expressions. The ML instructions are configured to train an AI model to infer at least one body pose based on at least one of the first set of data or the second set of data.

According to some embodiments, a method of the subject technology includes executing, by a processor, ML instructions, retrieving a first set of data from memory, and obtaining, by a communication module, from a cloud storage a second set of data. At least one of the first set of data or the second set of data includes a plurality of facial expressions and body poses. The ML instructions are configured to train an AI model to infer at least one body pose based on at least one of the first set of data or the second set of data.

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

In some aspects, the subject technology is directed to pose-based facial expressions. The disclosed technique provides capabilities for facial expression, for example, by inferring facial expression from body gestures using AI resources. The disclosed solution drives facial expression based on body tracking motions. In some aspects, the subject technology ties the facial expression to a number of features such as body pose, body motion, social context, application context. In some implementations, the above-mentioned features can be combined with audio and video tracking to better infer the facial expression.

In some aspects, the facial expression and/or appearance can be driven in a fitness activity while the user is working out or is engaged in a sport such as running, jumping, punching or any other activity that involves high velocity motions. In some aspects, the measured user's biometric data including a heart rate or a blood pressure may be used as an indication of working out and cause the avatar to breathe heavily, for example, expressed by nostril flaring or chest and/or neck being animated. In some aspects, the indication of working out can be expressed by changing of the color of the skin of the avatar, for example, by turning the color to red to signal getting hot.

In some aspects, the facial expression can be used to drive plausible body poses by using face tracking. In this case, the body poses can change based on the facial expression. For example, a body movement indicating an activity can be driven by sensing turning the color of skin of the avatar to red, flaring of the nostrils or movement of the chest or the neck of the avatar. The generation of the body motions can be valuable when only the face of the user is tracked, for example, by a mobile camera, but the body of the user is not in the field of view of the camera. This may happen when the user is an avatar in the horizon with only phone access.

Embodiments of the disclosed technology may include or be implemented in conjunction with an extra reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Extra reality content may include completely generated content or generated content combined with captured content (e.g., real-world photographs). The extra reality content may include video, audio, haptic feedback, or some combination thereof, any of which may be presented in a single channel or in multiple channels (such as stereo video that produces a three-dimensional effect to the viewer). Additionally, in some embodiments, extra reality may be associated with applications, products, accessories, services, or some combination thereof, that are, e.g., used to create content in an extra reality and/or used in (e.g., perform activities in) an extra reality. The extra reality system that provides the extra reality content may be implemented on various platforms, including a head-mounted display (HMD) connected to a host computer system, a standalone HMD, a mobile device or computing system, a “cave” environment or other projection system, or any other hardware platform capable of providing extra reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Examples of additional descriptions of XR technology which may be used with the disclosed technology are provided in U.S. patent application Ser. No. 18/488,482, titled, “Voice-enabled Virtual Object Disambiguation and Controls in Artificial Reality,” which is herein incorporated by reference. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

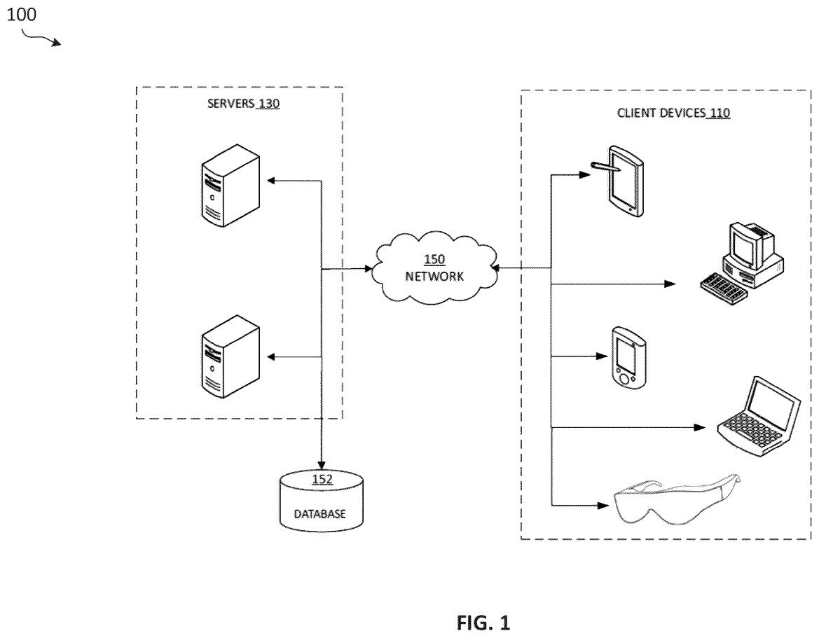

Turning now to the figures, FIG. 1 is a high-level block diagram illustrating a network architecture 100 within which some aspects of the subject technology are implemented. The network architecture 100 may include servers 130 and a database 152, communicatively coupled with multiple client devices 110 via a network 150. Client devices 110 may include, but are not limited to, laptop computers, desktop computers, and the like, and/or mobile devices such as smart phones, palm devices, video players, headsets (e.g., extra-reality (XR) headsets), tablet devices, and the like.

The network 150 may include, for example, any one or more of a local area network (LAN), a wide area network (WAN), the Internet, and the like. Further, the network 150 may include, but is not limited to, any one or more of the following network topologies, including a bus network, a star network, a ring network, a mesh network, a star-bus network, tree or hierarchical network, and the like.

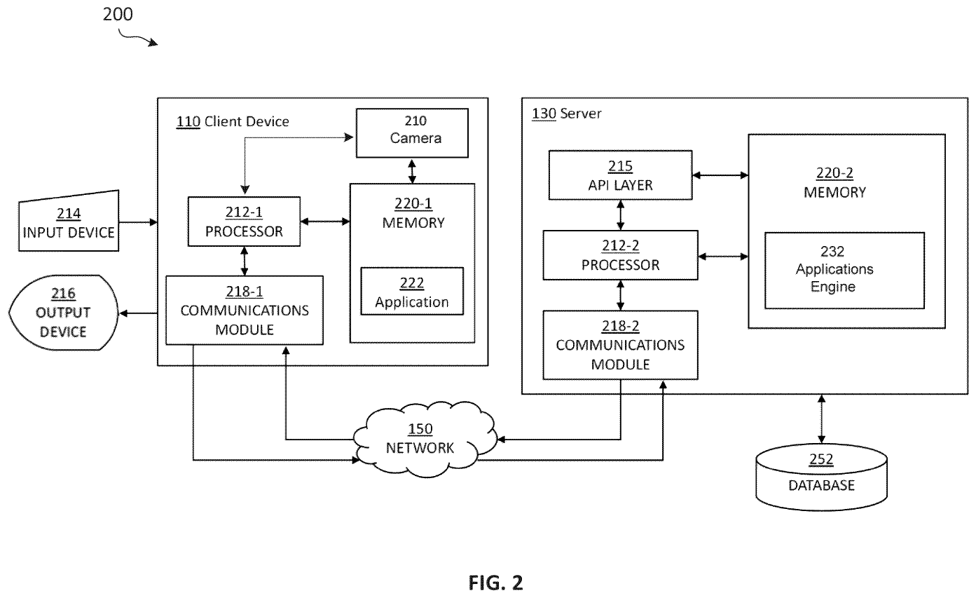

FIG. 2 is a block diagram illustrating details of a system 200 including a client device and a server, as discussed herein. The system 200 includes at least one client device 110, at least one server 130 of the network architecture 100, a database 252 and the network 150. The client device 110 and the server 130 are communicatively coupled over network 150 via respective communications modules 218-1 and 218-2 (hereinafter, collectively referred to as “communications modules 218”). Communications modules 218 are configured to interface with network 150 to send and receive information, such as requests, uploads, messages, and commands to other devices on the network 150. Communications modules 218 can be, for example, modems or Ethernet cards, and may include radio hardware and software for wireless communications (e.g., via electromagnetic radiation, such as radiofrequency (RF), near field communications (NFC), Wi-Fi, and Bluetooth radio technology).

The client device 110 may be coupled with an input device 214 and with an output device 216. A user may interact with the client device 110 via the input device 214 and the output device 216. Input device 214 may include a mouse, a keyboard, a pointer, a touchscreen, a microphone, a joystick, a virtual joystick, a touchscreen display that a user may use to interact with client device 110, or the like. In some embodiments, the input device 214 may include cameras, microphones, and sensors, such as touch sensors, acoustic sensors, inertial motion units and other sensors configured to provide input data to an XR system. Output device 216 may be a screen display, a touchscreen, a speaker, and the like.

The client device 110 may also include a camera 210 (e.g., a smart camera), a processor 212-1, memory 220-1 and the communications module 218-1. The camera 210 is in communication with the processor 212-1 and the memory 220-1. The processor 212-1 is configured to execute instructions stored in a memory 220-1, and to cause the client device 110 to perform at least some operations in methods consistent with the present disclosure. The memory 220-1 may further include application 222, configured to run in the client device 110 and couple with input device 214, output device 216 and the camera 210. The application 222 may be downloaded by the user from the server 130, and/or may be hosted by the server 130. The application 222 includes specific instructions which, when executed by processor 212-1, cause operations to be performed according to methods described herein. In some embodiments, the application 222 runs on an operating system (OS) installed in client device 110. In some embodiments, application 222 may run within a web browser. In some embodiments, the processor 212-1 is configured to control a graphical user interface (GUI) for the user of one of the client devices 110 accessing the server 130.

In some embodiments, the camera 210 is a virtual camera using an AI engine that can understand the user's body positioning and intent, which is different from existing smart cameras that simply keep the user in frame. The camera 210 can adjust the camera parameters based on the user's actions, providing the best framing for the user's activities. The camera 210 can work with highly realistic avatars, which could represent the user or a celebrity in a virtual environment by mimicking the appearance and behavior of real humans as closely as possible. In some embodiments, the camera 210 can work with stylized avatars, which can represent the user based on artistic or cartoon-like representations. In some embodiments, the camera 210 leverages body tracking to understand the user's actions and adjust the camera 210 accordingly. This provides a new degree of freedom and control for the user, allowing for a more immersive and interactive experience.

In some embodiments, the camera 210 is AI based and can be trained to understand the way to frame a user's avatar, for example, in a video communication application such as Messenger, WhatsApp, Instagram, and the like. The camera 210 can leverage body tracking, action recognition, and/or scene understanding to adjust the virtual camera features (e.g., position, rotation, focal length, aperture) for framing the user's avatar according to the context of the video call. For example, the camera 210 can determine the right camera position for different scenarios such as when the user is whiteboarding versus writing at a desk (overhead camera) or exercising. Each of these scenarios would require a different setup that could be inferred if the AI engine of the camera 210 can understand the context.

The database 252 may store data and files associated with the server 130 from the application 222. In some embodiments, the client device 110 collects data, including but not limited to video and images, for upload to server 130 using the application 222, to store in the database 252.

The server 130 includes a memory 220-2, a processor 212-2, an application program interface (API) layer 215 and communications module 218-2. Hereinafter, the processors 212-1 and 212-2, and memories 220-1 and 220-2, will be collectively referred to, respectively, as “processors 212” and “memories 220.” The processors 212 are configured to execute instructions stored in memories 220. In some embodiments, memory 220-2 includes an applications engine 232. The applications engine 232 may be configured to perform operations and methods according to aspects of embodiments. The applications engine 232 may share or provide features and resources with the client device, including multiple tools associated with data, image, video collection, capture, or applications that use data, images, or video retrieved with the application engine 232 (e.g., the application 222). The user may access the applications engine 232 through the application 222, installed in a memory 220-1 of client device 110. Accordingly, the application 222 may be installed by server 130 and perform scripts and other routines provided by server 130 through any one of multiple tools. Execution of the application 222 may be controlled by processor 212-1.

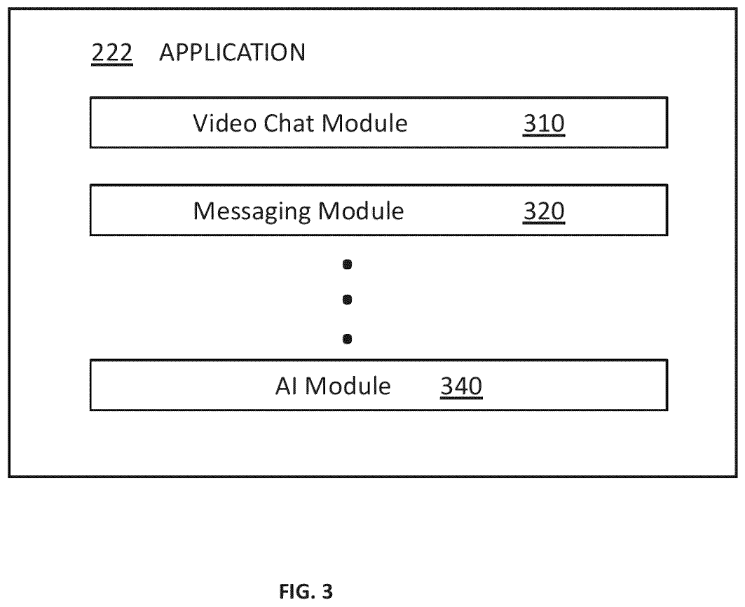

FIG. 3 is a block diagram illustrating examples of application 222 used by the client device of FIG. 2, according to some embodiments. The application 222 includes several application modules including, but not limited to, a video chat module 310, a messaging module 320 and an AI module 340. The video chat module 310 is responsible for operations of video chat applications such as Facebook Messenger, Zoom Meeting, Facetime, Skype, and the like and can control speakers, microphones, video recorders, audio recorders and similar devices. The messaging module 320 is responsible for operations of messaging applications such as WhatsApp, Facebook Messenger, Signal, Telegram and the like and can control devices such as cameras and microphones and similar devices.

The AI module 340 may include a number of AI models. AI models apply different algorithms to relevant data inputs to achieve the tasks, or an output for which the model has been programmed for. An AI model can be defined by its ability to autonomously make decisions or predictions, rather than simulate human intelligence. Different types of AI models are better suited for specific tasks, or domains, for which their particular decision- making logic is most useful or relevant. Complex systems often employ multiple models simultaneously, using ensemble learning techniques like bagging, boosting or stacking.

AI models can automate decision-making, but only models capable of machine learning (ML) are able to autonomously optimize their performance over time. While all ML models are AI, not all AI involves ML. The most elementary AI models are a series of if-then-else statements, with rules programmed explicitly by a data scientist. Machine learning models use statistical AI rather than symbolic AI. Whereas rule-based AI models must be explicitly programmed, ML models are trained by applying their mathematical frameworks to a sample dataset whose data points serve as the basis for the model's future real-world predictions.

The subject technology can use a system consisting of one or more ML models trained over time using a large database (e.g., database 252 of FIG. 2). In some implementations, the system can be trained to learn what the face looked like when the body engaged in certain activity. In some implementations, the system can use action recognition to understand the action that the user is doing and then drive the face to imitate or infer what the user's expression would be during these activities. In some implementations, the system can be multimodal, using both body movements and the tonality of the user's voice to drive facial expressions. In some implementations, when the user is engaged in a sports activity, the system can adapt to the genre of the sport activity, changing expressions based on the activity, such as boxing.

In some implementations, the system could also consider hand interactions and scene understanding to infer facial expressions to be driven. The output of the system is the inference of a facial expression, which could potentially be modified in post-processing steps. In some implementations, the system can return to a neutral, idle state after an intense activity, but it could also infer that the user just burned a significant number of calories and might be breathing hard or flushed. In some implementations, the system can maintain the inferred facial expression for a certain period of time after an intense activity, based on factors such as the age and weight of the user and the intensity of the workout. In some implementations, the body poses may be used to drive the facial expression, either wholesale or as an overlay. In some implementations, the system can calculate body motion velocities and understand motion vectors, to infer the strain that can be displayed on the face (e.g., squat, jump, jab or cross, kick, leap). In some implementations, the system can combine body gesture with audio expression to derive a new facial expression. The expressions that are additive and can maintain lip sync quality may be authored and saved by the AI module.

In some implementations, the system can consider social factors, e.g., in conjunction with a social graph. For example, if a user is competing with others, they might try to suppress their expressions. The system may use the user's social graph to attenuate the intensity of the expression. The system could also consider the expressions of other people around the person. For example, if a friend's avatar is super happy, the user may want to support them and be happy as well. This is referred to as body mimicry. In some implementations, the system can go beyond audio-driven lip sync. For example, the system may use audio to drive facial expressions and body gestures. In some implementations, given environment awareness, the scene understanding can be used as an input for a most plausible expression. In some implementations, people or social graphs (e.g., users' relationship to other avatars) can be used to infer expression according to relationships and historical interaction.

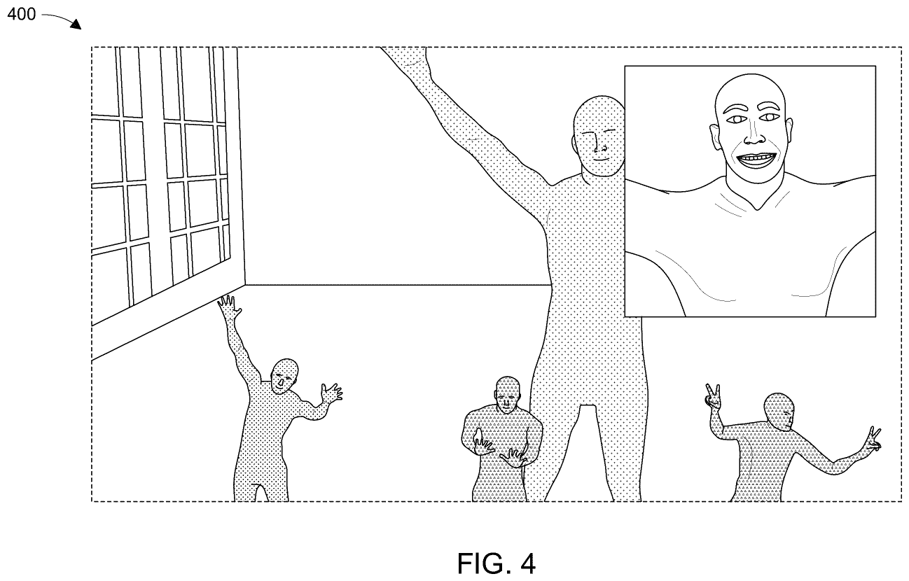

FIG. 4 is a screen shot 400 illustrating an example of a facial expression inferred from a form of a hand-in-the-air body gesture, according to some embodiments. FIG. 4 shows several example hand-in-the-air body gestures that are self-explanatory. The AI module 340 of FIG. 3 can be trained with these body gestures and similar ones to infer a facial expression that is indicative of, for example, an elated, thrilled, delighted or excited expression.

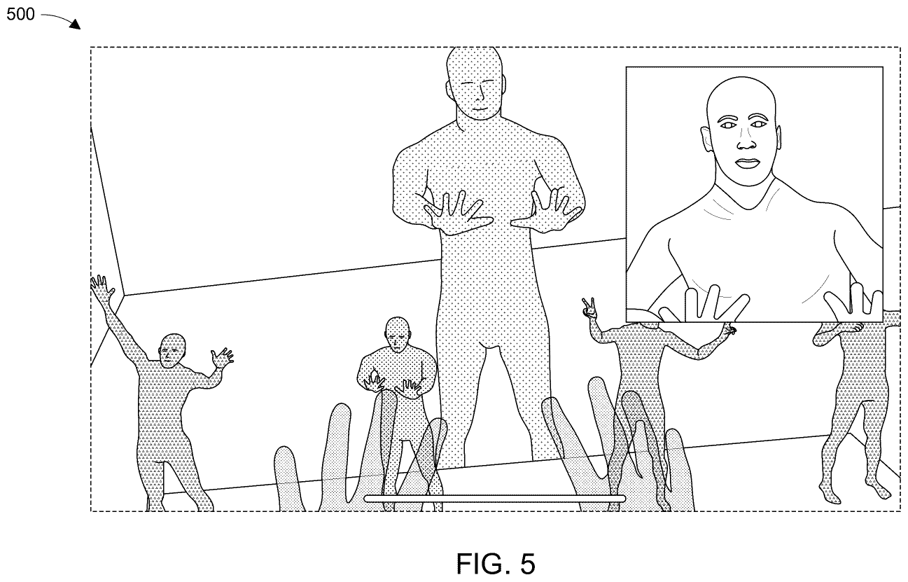

FIG. 5 is a screen shot 500 illustrating an example of a facial expression inferred from a form of a stop body gesture, according to some embodiments. Several examples of stop body gestures are shown in FIG. 5. These body gestures are just examples and are self-explanatory. The AI module 340 of FIG. 3 can be trained with these body gestures and similar ones to infer a facial expression that is indicative of, for example, a worried, anxious, upset, or nervous expression.

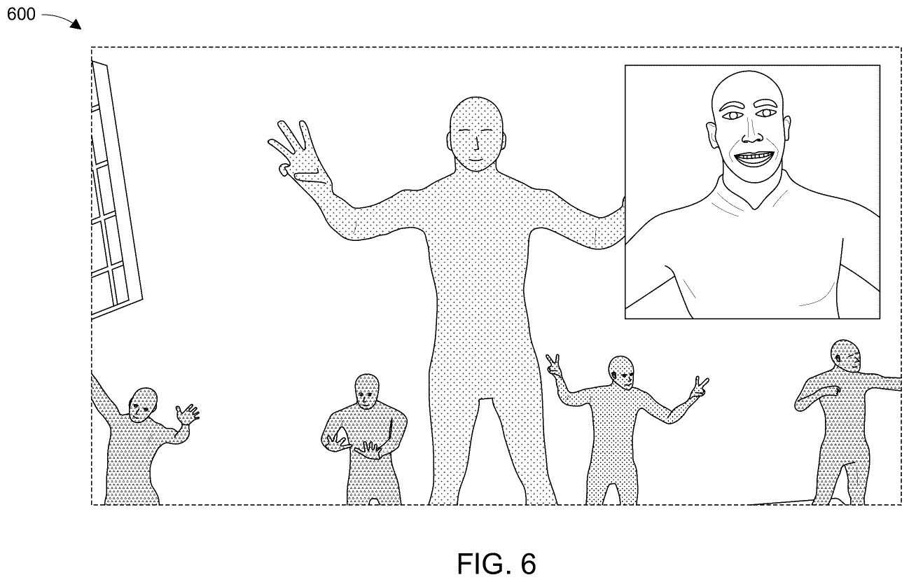

FIG. 6 is a screen shot 600 illustrating an example of a facial expression inferred from a form of a peace-sign body gesture, according to some embodiments. FIG. 6 depicts multiple examples of peace-sign body gestures that are self- explanatory. The AI module 340 of FIG. 3 can be trained with these body gestures and similar ones to infer a facial expression that is indicative of, for example, a happy, friendly or agreeable expression.

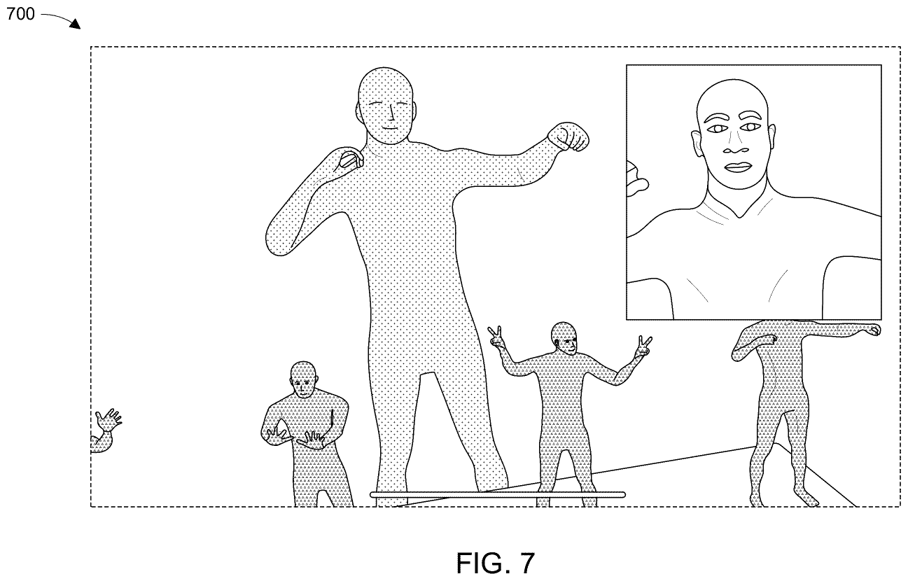

FIG. 7 is a screen shot 700 illustrating an example of a facial expression inferred from a form of a punching body gesture, according to some embodiments. Several examples of punching body gestures are shown in FIG. 5, which are just example body gestures and are self-explanatory. The AI module 340 of FIG. 3 can be trained with these body gestures and similar ones to infer a facial expression that is indicative of, for example, anger, rage or aggression expression.

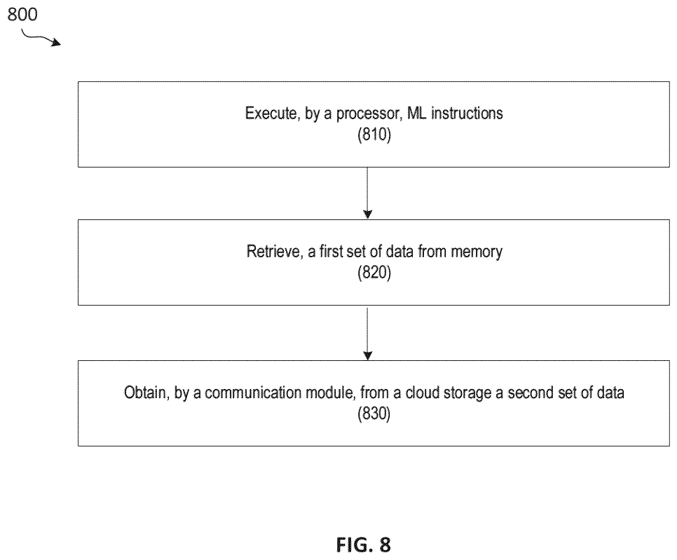

FIG. 8 is a flow diagram illustrating an example of a method 800 for inferring facial expression from body gestures, according to some embodiments. The method 800 includes executing, by a processor (e.g., 212-1 of FIG. 2), ML instructions (810), retrieving a first set of data from memory (e.g., 220-1 of FIG. 2) (820), and obtaining, by a communication module (e.g., 218-1 of FIG. 2), from a cloud storage a second set of data (830). At least one of the first set of data or the second set of data includes a plurality of facial expressions and body poses. The ML instructions are configured to train an AI model (e.g., from 340 of FIG. 3) to infer at least one body pose based on at least one of the first set of data or the second set of data.

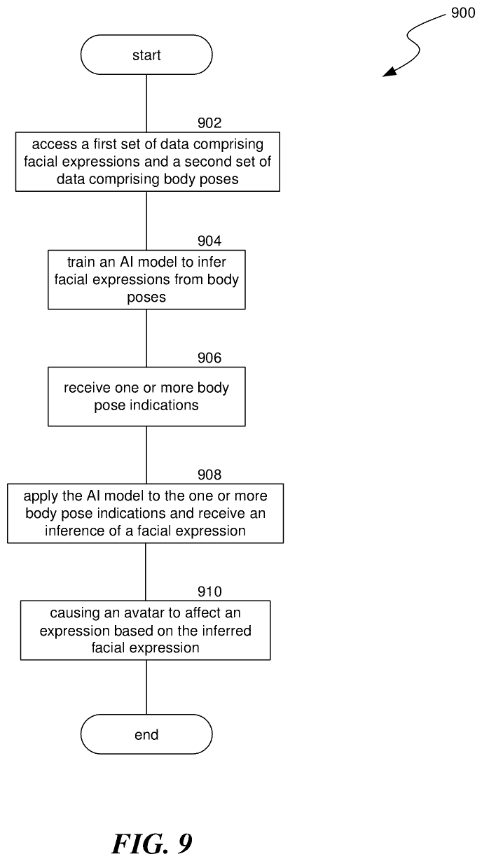

FIG. 9 is a flow diagram illustrating an example of a method 900 for inferring avatar facial expressions from captured user body pose data.

At block 902, process 900 can access a first set of data comprising facial expressions and a second set of data comprising body poses. Each body pose in the second set of data can be mapped to at least one facial expression in the first set of data. In some implementations, the second set of data can be based on images or video clips of body poses and each mapping for a body pose, corresponding to an image or video clip, can be based on facial expressions determined at the time the image or video clip was captured. In some implementations, the one or more body pose indications can be based on images from a virtual camera that uses an AI engine to determine the user's body positioning and process 900 can include, adjusting parameters of the virtual camera causing the virtual camera to frame the user's activities for improved pose capture.

In some cases, in addition to the body pose data, the second set of data can further include, associated with one or more of the body pose, biometric data including a heart rate or a blood pressure. In some cases, in addition to the body pose data, the second set of data can further include, associated with one or more of the body pose, voice data.

At block 904, process 900 can train, based on the mappings between the first set of data and the second set of data, an artificial-intelligence (AI) model to infer facial expressions when the AI model receives at least one or more body poses. In some implementations, the training of the AI model can further be based on associations between biometric data, from the second set, and one or more body poses mapped to facial expressions. In some cases, the training of the AI model can further be based on association between voice data, from the second set, and one or more body poses mapped to facial expressions;

At block 906, process 900 can receive one or more body pose indications. In some cases, the received one or more body pose indications are associated biometric data and/or a voice recording.

At block 908, process 900 can apply the AI model to the one or more body pose indications and can receive, from the AI model based on the training, an inference of a facial expression. In some implementations, applying the AI model to the one or more body pose indications further includes applying the AI model to biometric data associated with the received one or more body pose indications to infer the facial expression received from the AI model. In some cases, applying the AI model to the one or more body pose indications further includes applying the AI model to data based on a voice recording associated with the received one or more body pose indications to infer the facial expression received from the AI model.

At block 910, process 900 can cause an avatar to affect an expression based on the facial expression inferred by the AI model. For example, process 900 can cause the avatar to smile, frown, raise its eyebrows, blink, perform motions corresponding to speaking certain phonemes, etc.

In some implementations, process 900 can determine an expression of one or more users in a vicinity of a user, on which the one or more body pose indications are based, where the expression affected by the avatar is further based on the determined expression of the one or more users in the vicinity of the user. In some cases, the determining the expression of the one or more users in a vicinity of the user is in response to determining that the one or more users has a specified type of relationship, in a social graphs, to the user or determining that there is a record of one or more historical interactions between the one or more users and the user.

In some implementations, process 900 can determine that a user, on which the one or more body pose indications are based, is engaged in a competition, where the expression affected by the avatar is further based on the determining that the user is engaged in the competition. In some implementations, process 900 can identify above a threshold level of activity of a user, on which the one or more body pose indications are based and, in response to identifying above the threshold level of activity, can further cause the avatar to affect an increased activity expression. For example, the increased activity expression can be one or more of: flaring nostrils, an accelerated rate of chest and/or neck breathing animation, or an altered skin tone. In some cases, process 900 can compute a period of time based on one or more of: an age of the user, a weight of the user, a determined intensity of the activity of the user, or any combination thereof and can identify an end of the activity of the user, where process 900 can cause the avatar to maintain the increased activity expression for the computed period of time after end of the activity of the user. In some cases, identifying the level of activity of the user is based on calculated body motion velocities and/or motion vectors for the user.

An aspect of the subject technology is directed to a device including an XR headset comprising a processor configured to execute ML instructions, memory configured to store a first set of data and a communications module configured to access a cloud storage including a second set of data. The ML instructions are configured to train an AI model to infer facial expressions based on at least one of the first set of data or the second set of data.

In some implementations, the first set of data and the second set of data comprise images or video clips of body poses.

In one or more implementations, the body poses are provided by AI-powered body scanning.

In some implementations, the body poses comprise body motions in at least one of a social activity or a physical activity including a sports activity or a fitness activity.

In one or more implementations, the body poses are indicative of emotional states in one of a plurality of contexts.

In some implementations, the first set of data or the second set of data further comprise audio including environment sounds, music or voice.

In one or more implementations, the first set of data or the second set of data further comprise a measured user's biometric data including a heart rate or a blood pressure used to indicate an intensity of a physical activity.

In some implementations, the facial expressions include elated, thrilled, delighted or excited expressions inferred from a hand-in-the-air body gesture.

In one or more implementations, the facial expressions include worried, anxious, upset, or nervous expressions inferred from a form of a stop body gesture.

In some implementations, the facial expressions include happy, friendly or agreeable expressions inferred from a form of a peace-sign body gesture.

In one or more implementations, the facial expressions include anger, rage or aggression expressions inferred from a form of a punching body gesture.

Another aspect of the subject technology is directed to an apparatus comprising an XR headset including a processor configured to execute ML instructions, memory configured to store a first set of data and a communications module configured to access a cloud storage including a second set of data. At least one of the first set of data or the second set of data includes a plurality of facial expressions. The ML instructions are configured to train an AI model to infer at least one body pose based on at least one of the first set of data or the second set of data.

In some implementations, the plurality of facial expressions comprises elated, thrilled, delighted, excited, happy, friendly, agreeable, worried, anxious, upset, nervous, anger, rage, aggression expressions, nostril flaring, chest and neck being animated or changing of a skin color.

In one or more implementations, the at least one body pose comprises one or more of a hand-in-the-air body gesture, a stop body gesture, a peace-sign body gesture and a punching body gesture.

In some implementations, the at least one body pose is indicative of an emotional state in one of a plurality of contexts, wherein the at least one body pose comprises body motions in at least one of a social activity or a physical activity including a sports activity or a fitness activity.

In one or more implementations, the first set of data or the second set of data further comprise a measured user's biometric data including a heart rate or a blood pressure used to indicate an intensity of a physical activity.

In some implementations, the first set of data or the second set of data further comprise audio including environment sounds, music or voice.

Yet another aspect of the subject technology is directed to a method including executing, by a processor, ML instructions, retrieving a first set of data from memory, and obtaining, by a communication module, from a cloud storage a second set of data. At least one of the first set of data or the second set of data includes a plurality of facial expressions and body poses. The ML instructions are configured to train an AI model to infer at least one body pose based on at least one of the first set of data or the second set of data.

In one or more implementations, the ML instructions are configured to train an AI model to infer at least one facial expression based on at least one of the first set of data or the second set of data.

In some implementations, the first set of data or the second set of data further comprise a measured user's biometric data including a heart rate or a blood pressure used to indicate an intensity of a physical activity, and audio including environment sounds, music or voice.

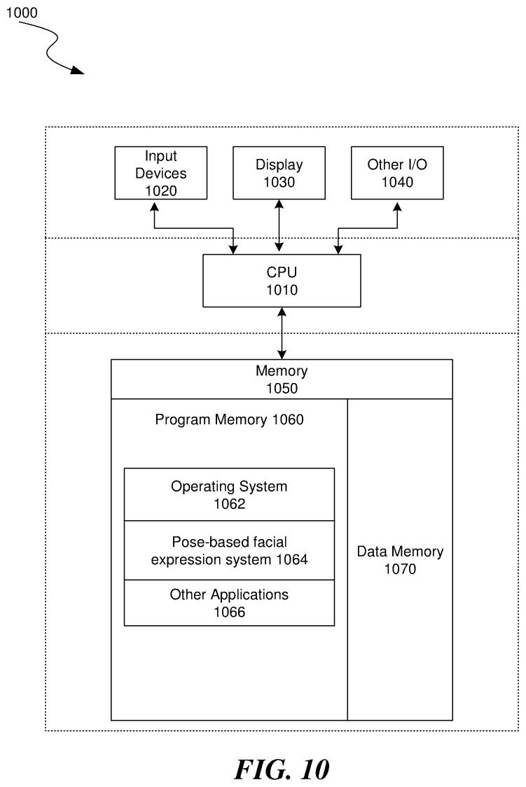

FIG. 10 is a block diagram illustrating an overview of devices on which some implementations of the disclosed technology can operate. The devices can comprise hardware components of a device 1000 that infers avatar facial expressions from captured user body pose data. Device 1000 can include one or more input devices 1020 that provide input to the Processor(s) 1010 (e.g. CPU(s), GPU(s), HPU(s), etc.), notifying it of actions. The actions can be mediated by a hardware controller that interprets the signals received from the input device and communicates the information to the processors 1010 using a communication protocol. Input devices 1020 include, for example, a mouse, a keyboard, a touchscreen, an infrared sensor, a touchpad, a wearable input device, a camera-or image-based input device, a microphone, or other user input devices.

Processors 1010 can be a single processing unit or multiple processing units in a device or distributed across multiple devices. Processors 1010 can be coupled to other hardware devices, for example, with the use of a bus, such as a PCI bus or SCSI bus. The processors 1010 can communicate with a hardware controller for devices, such as for a display 1030. Display 1030 can be used to display text and graphics. In some implementations, display 1030 provides graphical and textual visual feedback to a user. In some implementations, display 1030 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 1040 can also be coupled to the processor, such as a network card, video card, audio card, USB, firewire or other external device, camera, printer, speakers, CD-ROM drive, DVD drive, disk drive, or Blu-Ray device.

In some implementations, the device 1000 also includes a communication device capable of communicating wirelessly or wire-based with a network node. The communication device can communicate with another device or a server through a network using, for example, TCP/IP protocols. Device 1000 can utilize the communication device to distribute operations across multiple network devices.

The processors 1010 can have access to a memory 1050 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 1050 can include program memory 160 that stores programs and software, such as an operating system 1062, pose-based facial expression system 1064, and other application programs 1066. Memory 1050 can also include data memory 1070 that can include application data, configuration data, settings, user options or preferences, etc., which can be provided to the program memory 1060 or any element of the device 1000.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

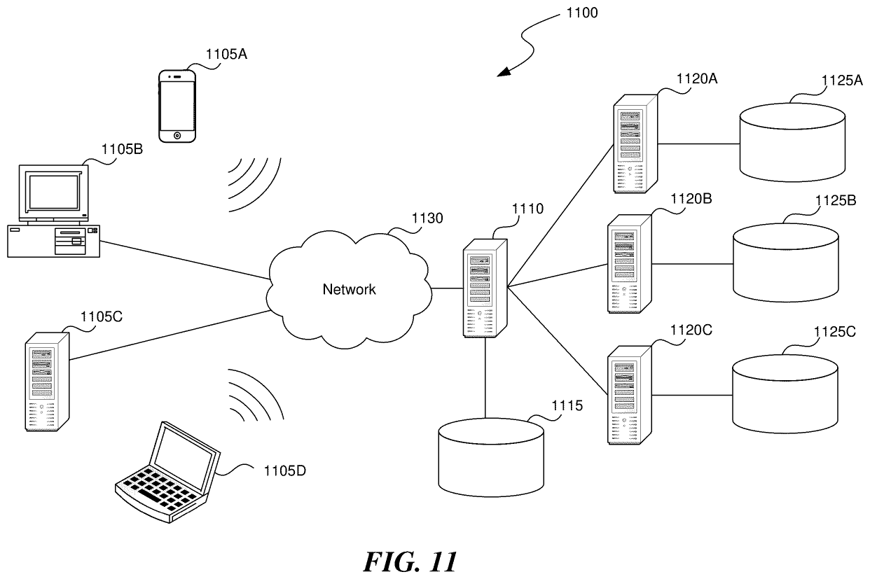

FIG. 11 is a block diagram illustrating an overview of an environment 1100 in which some implementations of the disclosed technology can operate. Environment 1100 can include one or more client computing devices 1105A-D, examples of which can include device 1000. Client computing devices 1105 can operate in a networked environment using logical connections through network 1130 to one or more remote computers, such as a server computing device.

In some implementations, server 1110 can be an edge server which receives client requests and coordinates fulfillment of those requests through other servers, such as servers 1120A-C. Server computing devices 1110 and 1120 can comprise computing systems, such as device 1000. Though each server computing device 1110 and 1120 is displayed logically as a single server, server computing devices can each be a distributed computing environment encompassing multiple computing devices located at the same or at geographically disparate physical locations. In some implementations, each server 1120 corresponds to a group of servers.

Client computing devices 1105 and server computing devices 1110 and 1120 can each act as a server or client to other server/client devices. Server 1110 can connect to a database 1115. Servers 1120A-C can each connect to a corresponding database 1125A-C. As discussed above, each server 1120 can correspond to a group of servers, and each of these servers can share a database or can have their own database. Databases 1115 and 1125 can warehouse (e.g. store) information. Though databases 1115 and 1125 are displayed logically as single units, databases 1115 and 1125 can each be a distributed computing environment encompassing multiple computing devices, can be located within their corresponding server, or can be located at the same or at geographically disparate physical locations.

Network 1130 can be a local area network (LAN) or a wide area network (WAN), but can also be other wired or wireless networks. Network 1130 may be the Internet or some other public or private network. Client computing devices 1105 can be connected to network 1130 through a network interface, such as by wired or wireless communication. While the connections between server 1110 and servers 1120 are shown as separate connections, these connections can be any kind of local, wide area, wired, or wireless network, including network 1130 or a separate public or private network.

In some implementations, servers 1110 and 1120 can be used as part of a social network. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g. indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age/date of birth, location (e.g. longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes in the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (e.g., via their personalized avatar) with objects or other avatars in an artificial reality environment, etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide an artificial reality environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

In some implementations, the word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

Aspects of the subject matter described in this disclosure can be implemented to realize one or more of the following potential advantages. The described techniques may be implemented to support a range of benefits and significant advantages of the disclosed eye tracking system. It should be noted that the subject technology enables fabrication of a depth-sensing apparatus that is a fully solid-state device with small size, low power, and low cost.

As used herein, the phrase “at least one of” preceding a series of items, with the terms “and” or “or” to separate any of the items, modifies the list as a whole, rather than each member of the list (i.e., each item).

To the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

1. A computer-implemented method for selective encryption in a shared artificial reality environment, the method comprising:
determining contextual information of the shared artificial reality environment, including determining at least one of: a status of an artificial reality compatible device, a power level associated with the artificial reality environment, and/or a connectivity status and adjusting a level of the selective encryption based on the determined device status, power level, and/or connectivity status;
encrypting, using the adjusted level of selective encryption, communication in the shared artificial reality environment into encrypted channels and non-encrypted channels based on the contextual information, wherein encrypting communication is based on a quantity of user representations and comprises determining a level of encryption for each virtual object of a plurality of virtual objects within the shared reality environment;
determining a first correlation between the encrypted channels and the non-encrypted channels;
determining a change in the contextual information of the shared artificial reality environment;
determining, based on the change in the contextual information, a second correlation between the encrypted channels and the non-encrypted channels;
applying, based on the second correlation, a partial encryption to the non-encrypted channels for obscuring a cryptographic code of the communication, wherein applying the partial encryption comprises determining key frames associated with the second correlation to define a beginning and an end of the partial encryption; and
determining a recombination of the encrypted channels and the non-encrypted channels based on clock skew, wherein the clock skew depends on both the quantity of user representations involved in the communication and a complexity of content rendered within the non-encrypted channels.

2. The computer-implemented method of claim 1, wherein determining the contextual information comprises determining at least one of: a user preference, a user parameter, or an artificial reality characteristic.

3. The computer-implemented method of claim 1, wherein determining the contextual information comprises receiving a user input indicative of a portion of the shared artificial reality environment being a private artificial reality environment.

4. The computer-implemented method of claim 1, wherein encrypting the communication in the shared artificial reality environment comprises:
encrypting the communication in the shared artificial reality environment based on a location corresponding to the contextual information.

5. The computer-implemented method of claim 1, wherein determining the first correlation between the encrypted channels and the non-encrypted channels comprises determining confidential components and non-confidential components of an event in the shared artificial reality environment.

6. The computer-implemented method of claim 1, wherein applying the partial encryption comprises obscuring information about an encrypted element of the encrypted channels.

7. The computer-implemented method of claim 1, wherein determining the recombination of the encrypted channels and the non-encrypted channels comprises determining, by a client device, a timing parameter for synchronized combination of the encrypted channels and the non-encrypted channels.

8. The computer-implemented method of claim 1, further comprising synchronizing encrypted audio or rendered virtual objects from the encrypted channels with non-encrypted audio or rendered virtual objects from the non-encrypted channels.

9. The computer-implemented method of claim 1, further comprising sending speech channels from a server for the shared artificial reality environment to a client device, wherein the speech channels comprise the encrypted channels and the non-encrypted channels.

10. The computer-implemented method of claim 1, further comprising:
determining a location within the shared artificial reality environment;
identifying, via the second correlation, sensitive spatial or audio information in the non-encrypted channels; and
applying, based on the second correlation, the partial encryption to the sensitive spatial or audio information of the non-encrypted channels.

11. A system for navigating through a shared artificial reality environment, comprising:
one or more processors; and
a memory comprising instructions stored thereon, which when executed by the one or more processors, causes the one or more processors to perform:
determining A) a quantity of user representations or location within the shared artificial reality environment and B) at least one of: a status of an artificial reality compatible device, a power level associated with the artificial reality environment, and/or a connectivity status;
determining, based on the quantity of the user representations or location, contextual information of the shared artificial reality environment;
adjusting a level of encryption based on the determined device status, power level, and/or connectivity status;
encrypting, using the adjusted level of encryption, communication in the shared artificial reality environment into encrypted channels and non-encrypted channels based on the contextual information wherein encrypting communication is based on a quantity of user representations and comprises determining a level of encryption for each virtual object of a plurality of virtual objects within the shared artificial reality environment;
determining a first correlation between the encrypted channels and the nonencrypted channels;
determining a change in the contextual information of the shared artificial reality environment;
determining, based on the change in the contextual information, a second correlation between the encrypted channels and the non-encrypted channels;
applying, based on the second correlation, a partial encryption to the non-encrypted channels for obscuring a cryptographic code of the communication, wherein applying the partial encryption comprises determining key frames associated with the second correlation to define a beginning and an end of the partial encryption; and
determining a recombination of the encrypted channels and the non-encrypted channels based on clock skew, wherein the clock skew depends on both the quantity of user representations involved in the communication and a complexity of content rendered within the non-encrypted channels.

12. The system of claim 11, wherein the instructions that cause the one or more processors to perform determining the contextual information cause the one or more processors to perform:
determining at least one of: a user preference, a user parameter, or an artificial reality characteristic; and
receiving a user input indicative of a portion of the shared artificial reality environment being a private artificial reality environment.

13. (canceled)

14. The system of claim 11, wherein the instructions that cause the one or more processors to perform determining the first correlation between the encrypted channels and the non-encrypted channels cause the one or more processors to perform determining confidential components and nonconfidential components of an event in the shared artificial reality environment.

15. The system of claim 11, wherein the instructions that cause the one or more processors to perform applying the partial encryption cause the one or more processors to perform obscuring information about an encrypted element of the encrypted channels.

16. The system of claim 11, wherein the instructions that cause the one or more processors to perform determining the recombination of the encrypted channels and the non-encrypted channels cause the one or more processors to perform determining, by a client device, a timing parameter for synchronized combination of the encrypted channels and the non-encrypted channels.

17. The system of claim 11, further comprising stored sequences of instructions, which when executed by the one or more processors, cause the one or more processors to perform synchronizing encrypted audio or rendered virtual objects from the encrypted channels with non-encrypted audio or rendered virtual objects from the non-encrypted channels.

18. The system of claim 11, further comprising stored sequences of instructions, which when executed by the one or more processors, cause the one or more processors to perform sending speech channels from a server for the shared artificial reality environment to a client device, wherein the speech channels comprise the encrypted channels and the non-encrypted channels.

19. The system of claim 11, further comprising stored sequences of instructions, which when executed by the one or more processors, cause the one or more processors to perform:
identifying, via the second correlation, sensitive spatial or audio information in the non-encrypted channels; and
applying, based on the second correlation, the partial encryption to the sensitive spatial or audio information of the non-encrypted channels.

20. A non-transitory computer-readable storage medium comprising instructions stored thereon, which when executed by one or more processors, cause the one or more processors to perform operations for navigating through a shared artificial reality environment, comprising:
determining A) a quantity of user representations or location within the shared artificial reality environment and B) at least one of: a status of an artificial reality compatible device, a power level associated with the artificial reality environment, and/or a connectivity status;
determining, based on the quantity of the user representations or location, contextual information of the shared artificial reality environment;
adjusting a level of encryption based on the determined device status, power level, and/or connectivity status;
encrypting, using the adjusted level of encryption, communication in the shared artificial reality environment into encrypted channels and non-encrypted channels based on the contextual information wherein encrypting communication is based on quantity of user representations and comprises determining a level of encryption for each virtual object of plurality of virtual objects within the shared artificial reality environment;
determining a first correlation between the encrypted channels and the non-encrypted channels;
determining a change in the contextual information of the shared artificial reality environment;
determining, based on the change in the contextual information, a second correlation between the encrypted channels and the non-encrypted channels;
identifying, via the second correlation, sensitive spatial or audio information in the non-encrypted channels;
applying, based on the second correlation, a partial encryption to the sensitive spatial or audio information of the non-encrypted channels for obscuring a cryptographic code of the communication, wherein applying the partial encryption comprises determining key frames associated with the second correlation to define a beginning and an end of the partial encryption; and
determining a recombination of the encrypted channels and the non-encrypted channels based on clock skew, wherein the click skew depends on both the quantity of user representations involved in the communication and a complexity of content rendered within the non-encrypted channels.
